(19) United States
(12) Patent Application Publication
(10) Pub. No.: US 2009/0323764 A1
(43) Pub. Date: Dec. 31, 2009

(54) TEMPERATURE SENSING CIRCUIT, ON DIE THERMAL SENSOR INCLUDING THE SAME, AND METHOD FOR SENSING TEMPERATURE

(75) Inventor: Jong-Man IM, Gyeonggi-do (KR)

Correspondence Address: IP & T Law Firm PLC, 7700 Little River Turnpike, Suite 207, Fairfax, VA, 22003, US

(73) Assignee: HYNIX SEMICONDUCTOR, INC., Gyeonggi-do (KR)

(21) Appl. No.: 12/326,752

(22) Filed: Dec. 2, 2008

(30) Foreign Application Priority Data
Jun. 30, 2008 (KR) 10-2008-0063164

(51) Int. Cl. G01K 7/00

(52) U.S. Cl. 374/183; 374/E07.001

(57) ABSTRACT

A temperature sensing circuit having high accuracy and an on die thermal sensor including the same are provided. The temperature sensing circuit includes a current generating unit for generating a temperature current varied according to a temperature, and a voltage generating unit for mirroring the temperature current and generating a temperature voltage generated by the mirrored temperature current.

### CROSS-REFERENCE TO RELATED APPLICATION

The invention claims priority of Korean patent application number 10-2008-0063164, filed on Jun. 30, 2008, which is incorporated by reference in its entirety.

### BACKGROUND OF THE INVENTION

The invention relates to a temperature sensing circuit and an ODTS (On Die Thermal Sensor) including the same, and more particularly, to a technology to sense a temperature at high accuracy.

The ODTS is a device for measuring a temperature of a semiconductor chip by being applied on the semiconductor chip. Particularly, the ODTS is applied to a current DRAM (Dynamic Random Access Memory) and hereinafter, the way of applying the ODTS to the DRAM will be described.

A cell of the DRAM includes a transistor which plays a role of a switch and a capacitor for storing electric charges (data). The data is classified into “high” (logic 1) and “low” (logic 0) according to whether there is electric charge in the capacitor of the memory cell or not, that is, whether a terminal voltage of the capacitor is high or low.

Maintenance of data is effected while the electric charge is accumulated in the capacitor and therefore in principle, power is not consumed. However, due to a leakage current by PN junction of an MOS (Metal Oxide Semiconductor) transistor or the like, an initially accumulated charge amount is deteriorated, and so the data may be lost. In order to prevent this, before the data is lost, it is needed to read the data in the memory cell and recharge a normal charge amount again according to the read information.

This operation should be periodically repeated so as to maintain capacitor charge, and therefore, the data. Such a process for recharging the electric charges of the cell is referred to as a refresh operation. Refresh control is generally performed by a DRAM controller. The need for the refresh operation causes refresh-power consumption in the DRAM. In a battery operated system needing low power, it is very important and a critical issue to reduce power consumption.

One approach for reducing the refresh-power consumption is to change a refresh period according to a temperature. A data retention time in the DRAM is longer as the temperature is lowered. Therefore, if a temperature region is divided into a plurality of regions and a frequency of a refresh clock is relatively lowered, the power consumption is certainly reduced. Accordingly, the ODTS is needed to exactly sense the temperature inside the DRAM and output information of the sensed temperature.

In addition, the DRAM generates more heat as an integration level and an operation speed are increased. The generated heat raises the temperature inside the DRAM, thereby to interrupt normal operation and to lead to an error of the DRAM. Accordingly, a device to exactly sense the temperature of the DRAM and output information of the sensed temperature is needed.

FIG. 1 is a view illustrating a conventional on die thermal sensor.

The on die thermal sensor includes a temperature sensing circuit 110 which outputs a temperature voltage Vtemp varied according to a temperature and an analog-digital converter 120 which converts the temperature voltage Vtemp into a digital thermal code.

Specifically, the temperature sensing circuit 110 senses the temperature based on the fact that a change of a base-emitter voltage Vbe of a BJT (Bipolar Junction Transistor) among bandgap circuits which are not influenced by a temperature or a power voltage is approximately −1.8 mV/° C. This way, a voltage VTEMP, having a one-to-one correspondence with the temperature, is outputted by amplifying the base-emitter voltage Vbe of the BJT which is finely varied. That is, the base-emitter voltage Vbe of the BJT, which decreases as the temperature rises, is outputted.

The analog-digital converter 120 converts the voltage VTEMP outputted from the temperature sensing unit 110 into a digital thermal code and outputs the thermal code. In general, a tracking analog-digital converter has been widely used.

FIG. 2 is a detailed circuit diagram of the conventional temperature sensing circuit 110.

The temperature sensing circuit 110 is a kind of bandgap circuit, and both parts for generating a temperature voltage VTEM and a reference voltage VREF are illustrated in the drawing. Generally, the bandgap circuits are designed to generate both the temperature voltage VTEMP and the reference voltage VREF.

First, the generation of the temperature voltage VTEMP will be described.

A base-emitter voltage VBE2 voltage of a BJT transistor Q2 is inputted to an operational amplifier 101 and voltages of two input stages(+,−) of the operational amplifier 101 are the same according to a virtual short principle. Therefore, VTEMP=(1+R10/R9)*VBE2. The base-emitter voltage VBE2 of the BJT transistor Q2 is varied according to the temperature and therefore a temperature voltage VTEMP obtained by amplifying the base-emitter voltage is also varied according to the temperature.

Hereinafter, the generation of the reference voltage VREF will be described.

Emitter currents of two BJT transistors Q1 and Q2 which are in the ratio of N:1, are expressed as the following equation.

I_{Q1}=Iₛ*exp [VBE1/V_{T}], I_{Q2}=N*I_{S}*exp [VBE2/V_{T}]

An IPTAT current which flows through a resistor R1 when electric potentials of a VBE1 and an X node are the same by the operational amplifier 101, is expressed as the following equation.

IPTAT=(VBE1−VBE2)/R1=ln(N*A)*V_{T/}R1

And, an ICTAT current which flows through a resistor R2 under the same condition, is expressed as the following equation.

ICTAT=VBE1/R2

That is, the IPTAT is a current which is increased in proportion to the temperature and the ICTAT is a current which is increased in inverse proportion to the temperature.

If the same current flows in MOS's with the same characteristics, the currents of M*IPTAT and K*ICTAT become the M*IPTAT and the K*ICTAT as indicated.

The reference voltage VREF which is outputted based on this, is expressed as the following equation.

VREF=K*R3/R2*(VBE1+(M*R3)/(K*R1)*ln(N*A)*V_{T})

When properly adjusting M, R1, R2, R3, K and M to compensate the temperature, although the temperature is varied, the reference voltage VREF always has a uniform value. In general, the reference voltage VREF is adjusted to have the uniform value regardless of the temperature by fixing the N, R1, R2 and R3 and adjusting only the K and the M.

Because the reference voltage VREF thus generated always has the uniform value in spite of the variation of the temperature, it is used as a reference voltage in various circuits of a chip.

As described above, the temperature voltage VTEM is expressed as the equation of VTEMP=(1+R10/R9)*VBE2, and because the VBE2 is varied according to the temperature, the temperature voltage VTEMP is also varied according to the temperature.

Meanwhile, the VBE2 is not varied only according to the variation of the temperature, but it is also influenced by a fabrication process variation. If the VBE2 is varied by the fabrication process variation of the BJT transistor, the temperature voltage is also varied.

Therefore, because the on die thermal sensor which outputs the thermal code by using the temperature voltage VTEMP is influenced by the fabrication process variation, there is generated an error in a measured temperature whenever a fabrication process is changed.

### SUMMARY OF THE INVENTION

Embodiments of the present invention are directed to providing a temperature sensing circuit for exactly sensing a temperature always in spite of a fabrication process variation and an ODTS (On Die Thermal Sensor) including the same.

In accordance with an aspect of the invention, there is provided a temperature sensing circuit including: a current generating unit configured to generate a temperature current varied according to a temperature; and a voltage generating unit configured to mirror the temperature current and generate a temperature voltage generated by the mirrored temperature current.

The current generating unit includes a first transistor and a second transistor, and the temperature current flows due to a difference between a base-emitter voltage of the first transistor and a base-emitter voltage of the second transistor.

In accordance with another aspect of the invention, there is provided an on die thermal sensor including: a current generating unit for generating a temperature current that varies according to a temperature; a voltage generating unit for mirroring the temperature current and generating a temperature voltage generated by the mirrored temperature current; and an analog-digital converting unit for converting and outputting the temperature current as a digital thermal code.

The current generating unit includes a first transistor and a second transistor and the temperature current is flows due to a difference between a base-emitter voltage of the first transistor and a base-emitter voltage of the second transistor.

In accordance with another aspect of the invention, there is provided a method for sensing a temperature including: generating a temperature current that varies according to a temperature; mirroring the temperature current; and supplying a temperature voltage generated by the temperature current.

### BRIEF DESCRIPTION OF THE DRAWINGS

FIG. 1 is a view illustrating a conventional on die thermal sensor.

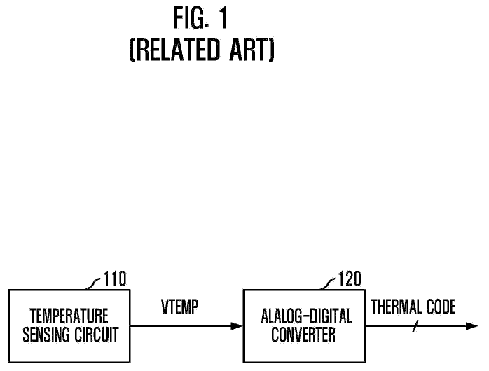

FIG. 2 is a detailed circuit diagram of a conventional temperature sensing circuit 110.

FIG. 3 is a block diagram illustrating an on die thermal sensor in accordance with the invention.

FIG. 4 is a construction illustrating a temperature sensing circuit 310 in accordance with one embodiment of the invention.

### DESCRIPTION OF SPECIFIC EMBODIMENTS

Hereinafter, to allow those skilled in the art to easily perform the spirit of the invention, preferred embodiments of the invention will be described in detail with reference to the accompanying drawings.

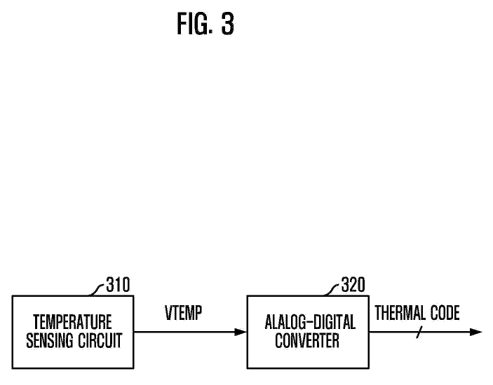

FIG. 3 is a construction illustrating an on die thermal sensor in accordance with the invention.

Referring to FIG. 3, the on die thermal sensor according to the invention includes a temperature sensing circuit 310 and an analog-digital converting unit 320.

A method for generating a temperature voltage VTEMP in the temperature sensing sensor 310 is different from a conventional method, which will described below.

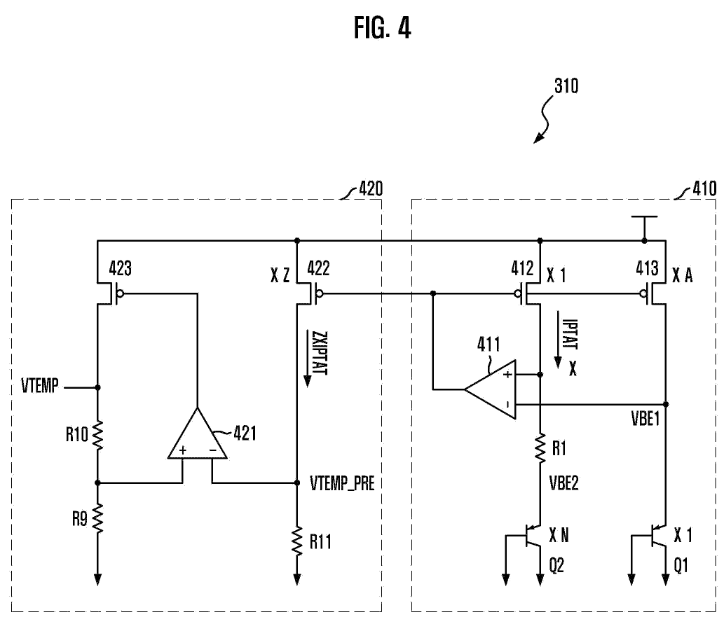

FIG. 4 is a construction illustrating a temperature sensing circuit 310 in accordance with one embodiment of the invention

The temperature sensing circuit 310 according to the invention includes a current generating unit 410 for generating a temperature current IPTAT which varies according to a temperature and a voltage generating unit 420 for mirroring the temperature current IPTAT and generating temperature voltages VTEMP_PRE and VTEMP(where VTEMP_PRE is amplified to VTEMP).

The current generating unit 410 generates the temperature current IPTAT with a current which flows due to a difference between a base-emitter voltage VBE1 of a first transistor Q1 and a base-emitter voltage VBE2 of a second transistor Q2.

The current generating unit 410 includes the first transistor Q1 in which a base and a collector are grounded; a resistor R1 connected between an emitter and a first node X of the first transistor Q1; a second transistor Q2 in which a base and a collector are grounded and an emitter is connected to a second node VBE1; an operational amplifier 411 uses the first node X and the second node VBE2 as inputs; a third transistor 412 for supplying a current to the first node X in response to output of the operational amplifier 411; and a fourth transistor 413 for supplying a current to the second node VBE2 in response to the output of the operational amplifier 411.

The voltage generating unit 420 generates the temperature voltage VTEMP_PRE with a voltage generated by a voltage drop occurring while the mirrored current flows in a resistor R11. The temperature voltage VTEMP is outputted by amplifying the temperature voltage VTEMP_PRE. Naturally, the unamplified VTEMP_PRE may be used as the temperature voltage(both the VTEMP_PRE and the VTEMP may be the temperature voltage).

The voltage generation unit 420 includes a fifth transistor 422 for supplying a current to the voltage generating unit 420 in response to the output of the operational amplifier 411; and the resistor R11 for supplying the temperature voltage VTEMP_PRE by being connected between the fifth transistor 422 and a ground stage. And, it further includes an operational amplifier 421 to amplify and output the voltage VTEMP_PRE, resistors R10 and R9, and another transistor 423.

Hereinafter, a method for generating the temperature voltage VTEMP in the temperature sensing circuit 310 will be described together with the following equations.

The emitter currents of the two BJT transistors Q1 and Q2 which are in the ratio of N:1, are expressed as the following equation.

I_{Q1}=Iₛ*exp [VBE1/V_{T}], I_{Q2}=N*Iₛ*exp [VBE2/V_{T}] Eq.1

And, a relational expression between the I_{Q1}, and I_{Q2} is obtained as follows.

I_{Q1}=A*I_{Q2} Eq.2

The IPTAT current, which flows through the resistor R1 when electric potentials of the VBE1 and the X node are the same by the operational amplifier 411, is expressed as the following equation.

IPTAT=(VBE1−VBE2)/R1 Eq.3

If arranging the equation 3 by using the equation 1 and the equation 2, the following equation is obtained.

IPTAT=ln(N*A)*V_{T}/R1

Therefore, the mirrored current is expressed as the equation of, Z*IPTAT=Z*ln(N*A)*V_{T}/R1An and the temperature voltage is expressed as the equation of VTEMP_PRE=(Z*(R11/R1)*VT)*ln(N*A).

The temperature voltage VTEMP according to the invention, which is obtained by amplifying the VTEMP_PRE, is expressed as the following equation.

VTEMP=(1+R10/R9)*(Z*R11/R1)*ln(N*A)*V_{T}

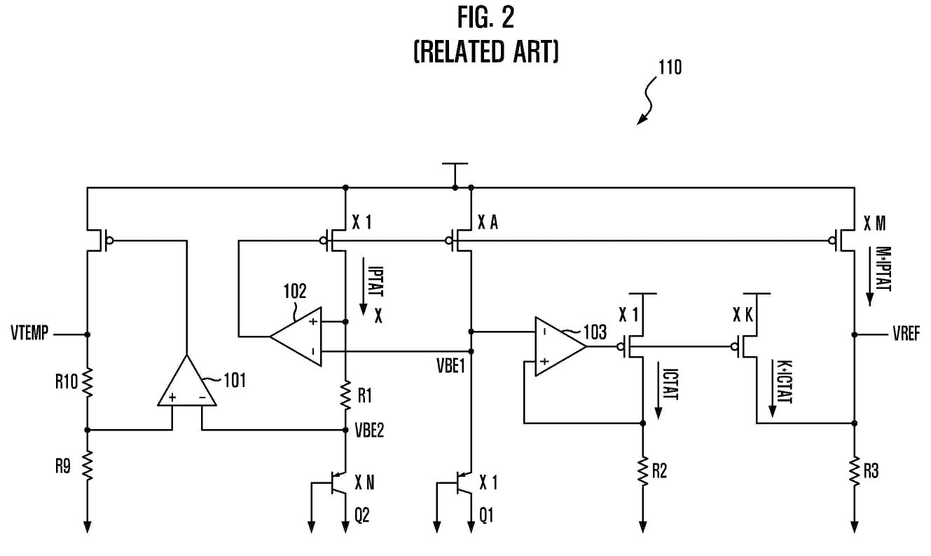

A conventional temperature voltage is expressed as the equation of VTEMP(conventional)=(1+R10/R9)*VBE2 (see the description of FIG. 2). And, since the VBE2 is considerably influenced by a process variation as well as the temperature, there is a problem in accuracy of the conventional temperature voltage.

However, the temperature voltage VTEMP according to the invention is expressed as the equation of VTEMP(invention)=(1+R10/R9)*(Z*R11/R1)*ln(N*A)*V_{T}. That is, since a VBE term is removed from the equation related to the temperature voltage VTEMP, the influence due to the fabrication process variation is removed. Therefore, when using the temperature voltage VTEMP according to the invention, it is possible to exactly measure the temperature always although there is the fabrication process variation.

As described above, the invention generates the temperature current by using the difference between the base-emitter voltages of the two transistors and generates the temperature voltage by mirroring the temperature current.

Accordingly, the temperature voltage in the invention is not influenced by the fabrication process variation and when using the temperature voltage, it is possible to exactly measure the temperature regardless of the fabrication process variation.

While the invention has been described with respect to the specific embodiments, it will be apparent to those skilled in the art that various changes and modifications may be made without departing from the spirit and scope of the invention as defined in the following claims.

What is claimed is:

1. A temperature sensing circuit comprising a current generating unit configured to generate a temperature current varied according to a temperature, and a voltage generating unit configured to mirror the temperature current and generate a temperature voltage based on the mirrored temperature current.

2. The temperature sensing circuit as recited in claim 1, wherein the current generating unit includes a first transistor and a second transistor, and wherein the temperature current flows due to a difference between a base-emitter voltage of the first transistor and a base-emitter voltage of the second transistor.

3. The temperature sensing circuit as recited in claim 1, wherein the current generating unit includes:
a first transistor having a grounded base and a grounded collector;
a resistor connected between an emitter of the first transistor and a first node;
a second transistor having a grounded base and a grounded collector, and having an emitter connected to a second node;
an operational amplifier having a first input connected to the first node and a second input connected to the second node;
a third transistor configured to supply current to the first node in response to an output of the operational amplifier; and
a fourth transistor configured to supply current to the second node in response to the output of the operational amplifier.

4. The temperature sensing circuit as recited in claim 3, wherein the voltage generating unit includes:
a fifth transistor configured to supply current to the voltage generating unit in response to the output of the operational amplifier; and
a resistor connected between the fifth transistor and a ground terminal to supply the temperature voltage.

5. The temperature sensing circuit as recited in claim 1, wherein the voltage generating unit supplies the temperature voltage in response to a voltage drop which is produced along a path of the mirrored temperature current.

6. The temperature sensing circuit as recited in claim 1, wherein the voltage generating unit amplifies and outputs the temperature voltage.

7. The temperature sensing circuit as recited in claim 2, wherein the first transistor and the second transistor have characteristics different than each other.

8. An on die thermal sensor comprising:
a current generating unit configured to generate a temperature current varied according to a temperature;
a voltage generating unit configured to mirror the temperature current and generate a temperature voltage based on the mirrored temperature current; and
an analog-digital converting unit configured to convert the temperature voltage to a digital thermal code.

9. The on die thermal sensor as recited in claim 8, wherein the current generating unit includes a first transistor and a second transistor, and wherein the temperature current flows due to a difference between a base-emitter voltage of the first transistor and a base-emitter voltage of the second transistor.

10. The on die thermal sensor as recited in claim 8, wherein the current generating unit includes:
a first transistor having a grounded base and a grounded collector;
a resistor connected between an emitter of the first transistor and a first node
a second transistor having a grounded base and a grounded collector, and having an emitter connected to a second node;
an operational amplifier configured to amplify voltages at the first node and the second node;
a third transistor configured to supply current to the first node in response to an output of the operational amplifier; and
a fourth transistor configured to supply current to the second node in response to the output of the operational amplifier.

11. The on die thermal sensor as recited in claim 10, wherein the voltage generating unit further includes:
a fifth transistor configured to supply a current in response to the output of the operational amplifier; and
a resistor connected between the fifth transistor and a ground terminal to receive the current supplied by the fifth transistor so as to provide thereacross the temperature voltage.

12. The on die thermal sensor as recited in claim 8, wherein the voltage generating unit supplies the temperature voltage in response to a voltage drop which is produced along a path of the mirrored temperature current.

13. The on die thermal sensor as recited in claim 8, wherein the voltage generating unit amplifies and outputs the temperature voltage.

14. The on die thermal sensor as recited in claim 8, wherein the first transistor and the second transistor have characteristics different than each other.

15. A method for sensing a temperature comprising:
generating a temperature current varied according to a temperature;
mirroring the temperature current; producing a voltage drop along a path of the mirrored temperature current; and
supplying a temperature voltage indicative of the temperature based on the voltage drop.

16. The method as recited in claim 15, wherein said generating a temperature current includes generating the temperature current based on a difference between base-emitter voltages of two different transistors.
